(19) United States
(12) Patent Application Publication
(10) Pub. No.: US 2025/0353320 A1
(43) Pub. Date: Nov. 20, 2025

(54) ERASABLE DISPLAY SYSTEM

(71) Applicant: Jackson Probst, Chandler, AZ (US)

(72) Inventor: Jackson Probst, Chandler, AZ (US)

(21) Appl. No.: 19/182,743

(22) Filed: Apr. 18, 2025

Related U.S. Application Data
(60) Provisional application No. 63/649,625, filed on May 20, 2024.

(51) Int. Cl. B43L 1/12; B42D 5/04

(52) U.S. Cl. CPC B43L 1/123; B42D 5/041; B42D 5/047

(57) ABSTRACT

An erasable display system featuring a frame with front and back portions forming a hollow center, connected by first and second side panels containing rod-receiving apertures. First and second rods extend rotatably between the side panels, supporting a continuous loop of flexible writeable film that advances through user rotation. The system may include an eraser mechanism that automatically cleans the film during rotation, with adjustable pressure capability. Side panels can incorporate holders for markers and erasers. The film features a specialized coating for effective marking and erasing.

### CROSS REFERENCE TO RELATED APPLICATIONS

This application claims benefit from currently pending U.S. Provisional Application No. 63/649,625 titled “ERASABLE DISPLAY SYSTEM” and having a filing date of May 20, 2024, all of which is incorporated by reference herein.

### FIELD OF THE INVENTION

The field of the disclosed technology relates to display systems, particularly to erasable display systems designed for scheduling and calendar applications, which enable easy updates and revisions. This technology focuses on systems that incorporate mechanisms for manual or automated updating of displayed information, utilizing dry erase surfaces and associated components for dynamic content management.

### BACKGROUND OF THE INVENTION

The field of scheduling and organizational tools has experienced significant development, particularly with tools used in both domestic and institutional environments. Historically, these tools, such as dry erase boards and paper calendars, play critical roles in planning and tracking events but also feature notable limitations. Dry erase boards are prevalent due to their reusability and the ease of writing and erasing. Made from materials like porcelain or melamine, these boards support writing with non-permanent markers that are easily erasable. However, they necessitate manual cleaning, which becomes laborious with frequent content changes. Furthermore, such boards are prone to ghosting or staining over time, where remnants of past writings continue to be visible, thus reducing their clarity and utility.

Paper calendars offer a physical method to track and view events across different periods such as monthly, weekly, or daily. However, once entries are made, adjustments are cumbersome and typically result in visual clutter due to erasing or overwriting, reducing their efficiency. Additionally, the inherent non-reusability necessitates frequent replacements, leading to ongoing costs and environmental impact from paper waste. Both traditional systems—dry erase boards and paper calendars—are limited in environments with dynamic schedules requiring frequent updates. The manual erasure process on dry erase boards is often time-consuming and incomplete, while paper calendars lack the flexibility for updates without physical replacements, limiting their effectiveness in fast-paced scenarios.

While technological advancements have led to the creation of digital scheduling tools like online calendars and apps, these solutions, though dynamic, often lack the physical presence and easy accessibility provided by wall-mounted systems. Moreover, they frequently necessitate electronic devices and internet connectivity, which might not be available consistently across all settings. Despite the existence of digital alternatives, there persists a clear necessity for an improved physical scheduling tool that marries the accessibility of traditional tools with the dynamic updating capabilities of digital technologies.

Given the current landscape, what is needed is a physical scheduling solution that integrates the traditional utility of dry erase boards and paper calendars with the dynamic and automated update capabilities found in digital tools. There exists a demand for a system that facilitates the easy, continuous update of information with minimal manual intervention, while maintaining utmost visibility and usability. Such a system should offer significant improvements over traditional methodologies by mitigating their inherent disadvantages, and by deploying a mechanism for continuous and automated renewal of the display surface, thereby addressing both the issues of erasability and permanence in a novel manner.

Therefore, there is a need for an erasable display system that overcomes these limitations, providing an efficient, clean, and user-friendly solution for writing and erasing content.

So as to reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

U.S. Pat. Nos. 4,462,134, and 4,742,594 which focuses on handheld erasers for blackboards, and U.S. Pat. Nos. 3,731,335 and 3,858,265 concern automatic chalkboard erasers mounted on conventional chalkboards. However, these inventions do not address the limitations of fixed writing space, potential obstruction of view, and the need for continuous, uninterrupted writing and display of information.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### SUMMARY OF THE INVENTION

The present invention provides an erasable display system can comprise a frame having an exterior and a back, a top, a bottom, a first side and a second side defining a hollow interior with an open front. A first rod can run between the first side and the second side and a second rod can run between the first side and the second side parallel to the first rod, wherein at least one of the first rod and the second rod can have at least one rotation knob that is accessible from the exterior of the frame. A flexible, writeable film material can be scrolled between and around the first rod and the second rod, wherein the film material is configured to be selectively advanced by operation of the at least one rotation knob. The erasable display system can further comprise an eraser mounted on the frame, positioned to contact the film material upon rotation of the at least one rotation knob and configured to remove markings from the film.

The at least one knob can be a first knob coupled to the first rod about the first side and a second knob coupled to the first rod about the second side. The film can have an easy-erase coating. The frame, rods, and at least one rotation knob are selected from at least one of wood, metal, and plastic. The film can be made from a polymer selected from at least one of polyethylene and polypropylene. The erasable display system can further comprise a calendar template configured to allow the film to be used as a progressable calendar.

The system can further comprise a motor coupled to at least one of the first rod and the second rod configured to automatically rotate the at least one of the first rod and the second rod to advance the film in response to user settings. The motor can be coupled to at least one of the first rod and the second rob by a gear and/or a belt. The erasable motor operation can be controlled by a microcontroller for timing or triggering the rotation of the dry erase film based on user inputs. The erasable display system can further comprise an adjustable eraser pressure mechanism, wherein the pressure with which the eraser contacts the film is adjustable.

The erasable display system can further comprise a tension adjustment mechanism configured to adjust the tension of the film to keep it taut and optimal for writing and erasing. The first side panel and/or the second side panel has at least one marker holder and at least one eraser holder. The first rod can have a first end that passes through a first rod aperture on the first side of the frame. The calendar template can include an open space in addition to the calendar days configured to allow a user to write additional notes outside of the calendar.

A method of assembling an erasable display system, can comprise providing a frame having an exterior and a front, a back, a top, a bottom, a first side and a second side defining a hollow interior. Coupling a first rod to run between the first side and the second side and a second rod to run between the first side and the second side parallel to the first rod. Providing access to at least one of the first rod and the second rod to allow a user to rotate the first rod and/or the second rod. Scrolling a flexible, writeable film material between and around the first rod and the second rod. The method coupling a template about the film to give a writeable format to the film. The method can comprise coupling an eraser to the frame such that advancing the film passes a portion of the film that has been written on into contact with the eraser to erase any writing on the film that passes by the eraser. The method can further comprise coupling a controllable motor to at least one of the first rod and the second rod to automatically advance the film. The method can further comprise forming at least one of at least one marker holder and at least one eraser holder in the frame.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF DRAWINGS

A more complete understanding of the present invention may be derived by referring to the detailed description when considered in connection with the following illustrative figures. In the figures, like reference numbers refer to like elements or acts throughout the figures.

FIG. 1 depicts a front view of an erasable display system in accordance to one or more embodiments;

FIG. 2 depicts an isometric front view of another embodiment of an erasable display system in accordance to one or more embodiments;

FIG. 3a depicts a front view of another embodiment of an erasable display system in accordance to one or more embodiments;

FIG. 3b depicts a cross-sectional view of FIG. 3a of another embodiment of an erasable display system in accordance to one or more embodiments;

FIG. 3c depicts a close-up view of FIG. 3b of another embodiment of an erasable display system in accordance to one or more embodiments;

FIG. 4 depicts a left side view of another embodiment of an erasable display system in accordance to one or more embodiments;

FIG. 5 depicts a top view of another embodiment of an erasable display system in accordance to one or more embodiments;

FIG. 6 depicts a back view of another embodiment of an erasable display system in accordance to one or more embodiments;

FIG. 7a depicts a right-side view of another embodiment of an erasable display system in accordance to one or more embodiments;

FIG. 7b depicts a cross-sectional view of FIG. 7b of another embodiment of an erasable display system in accordance to one or more embodiments; and

FIG. 8 depicts a exploded view of another embodiment of an erasable display system in accordance to one or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

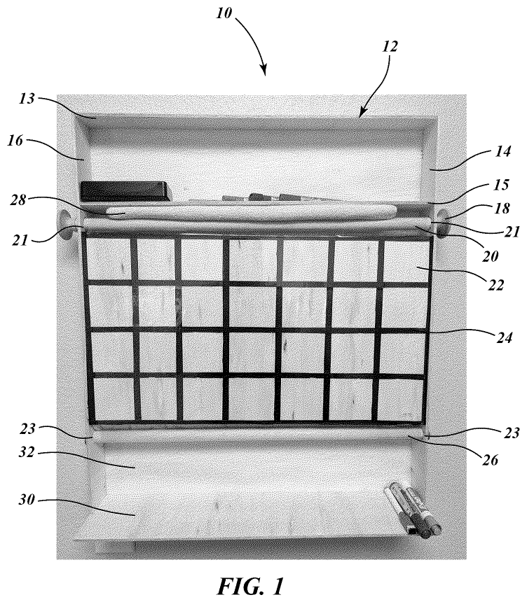

Referring to FIG. 1, an erasable display system is shown generally at 10. The system 10 comprises a frame 12, which includes a top member 13 and a bottom member 30. These members can be coupled together by a first side member 14 and a second side member 16. The first side member 14 and the second side member 16 can be coupled to the top member 13 and the bottom member 30 by such as, for example, fasteners, adhesive, rivets, weld, or the like. The first side member 14, the second side member 16, the top member 13 and the bottom member 30 can be made from such as, for example, wood, metal, ceramic, composite, or the like. The first side member 14 and the second side member 16 can have at least two side holes 21, 23 that are aligned with each other. The first side member 14 and the second side member 16 can have a back member 32 extending between the first side member and the second side member. The back member 32 can be made from such as, for example, wood, metal, ceramic, composite, or the like. The back member can provide a backing to the system 10.

The system can further comprise a first rod 20 and a second rod 26. The first rod 20 and the second rod 26 can be rotatably mounted on the first side member 14 and the second side member 16 through the at least two side holes 21, 23. The first side rod 20 and the second rod 26 can be such as, for example, solid rod, hollow rod, dowel pin, steel rod, wooden rod, or the like. In certain embodiments, the first rod 20 and the second rod 26 can be on bearings that are coupled to the at least two side holes 21, 23 allowing the rods to freely rotate and can have a gear coupled to the at least one of the first rod and/or second rod and a ratchet coupled to at least one of the first side member 14 and the second side member 16 wherein the ratchet and gear can let the rods rotate at a distance and keep the rods from rotating backwards. The first rod 20 can have at least one handle 18 coupled to at least one of its ends. The handle 18 can be such as, for example, grip handle, wing handle, knob handle, wheel handle, lever handle, or the like. The handle 18 can be removable from the first rod 20. In certain embodiments, the at least one handle can be attached to at least one end of the second rod 26.

In embodiments, a film 24 can be suspended between the first rod 20 and the second rod 26 and can be a continuous film that can be selectively moved around the first rod and the second rod as the first rod and/or second rod rotate allowing the film to selectively displayed on the erase film's front side, for example, a week can be rolled and cleaned off so it can show the previous three weeks can be shown with a new row on the bottom. This film 24 is designed to facilitate easy and effective erasing of a dry erase marker upon rotation of the rods. The film 24 can be made from such as, for example, a polymer, polypropylene, polyethylene terephthalate, polyvinyl chloride, or the like. The film 24 can be made from a flexible substrate allowing it to be wrapped partially around the first rod 20 and partially around the second rod 26. The film 24 can be such as, for example, clear, white with boxes, clear with boxes, or the like. The handle 18 can allow the user to turn the first rod 20, the film 24 and/or second rod 26.

The erasable display system 10 can further comprise an erasing mechanism 28. The erasing mechanism 28 can be mounted on the frame and can be positioned to contact the film 24 upon rotation. The eraser mechanism 28 can be designed to remove markings from the film 24. The pressure with which the eraser mechanism 28 contacts the film 24 can be adjusted based on user preference or the type of markers used. The erasing mechanism 28 can be such as, for example, felt, foam, microfiber, rubber, or the like. The erasing mechanism 28 can remove any ink particles, ensuring the film is ready for immediate use. The erasing mechanism 28 can be removably attached to an erasing member 15 which can extend from the first side member 14 and the second side member 16.

In certain embodiments, the erasing mechanism 28 can be a dry eraser and a wet eraser wherein the film can pass by the wet eraser and moisten the film and the dry eraser can dry the moisten film and remove and streaks or extra dry erase marks from the film. The wet eraser section can have a reservoir for a cleaning solution such as water or mild detergent and an absorbent, replaceable pad. The wet eraser can be positioned such that it contacts the film 24 as it is rolled around the upper rod 20 or lower rod 26. The wet eraser can loosen and remove the ink and debris from the film's surface. The dry eraser section can be positioned downstream from the wet eraser to engage the film after it has been cleaned with the wet eraser. The dry eraser removes any remaining moisture and residual ink particles, ensuring the film is dry and ready for immediate use.

The erasable display system 10 can further comprise a back supporting member 22 which can extend from the first side member 14 to the second side member 16 and can sit behind the film 24. The back supporting member 22 can be such as, for example, wood, metal, ceramic, composite, or the like. The back supporting member 22 can allow for the user to write using a dry erase marker on the film 24. The film support can be blank or can have boxes evenly or unevenly spaced wherein each box represents a day of the week. The film support can be coupled to the first side member 14 to the second side member 16 by such as, for example, fastener, adhesive, rivets, press fit, dowl pins, or the like. The film support can have a thickness giving the film support for the user to write on the film 24 and can allow for the film to wrap around its backside allowing it to come into contact with the erasing mechanism 28. In certain embodiments, the back supporting member 22 can be removable allowing the user access to the erasing mechanism 28.

In other embodiments, the system 10 can include a motor that is coupled to the either the first rod 20 or the second rod 26 by at least one gear and/or a belt system. The motor can be adapted for automated rotation of the dry erase film 24 in response to user settings. The operation of the motor is controlled by a microcontroller for timing or triggering the rotation of the dry erase film based on user inputs. The system 10 can also include a tension adjustment mechanism wherein the tension adjustment can be configured to adjust the tension of the dry erase film 24 to keep it taut and optimal for writing and erasing. The system 10 can be designed for usage in various environments, including homes, offices, or educational institutions.

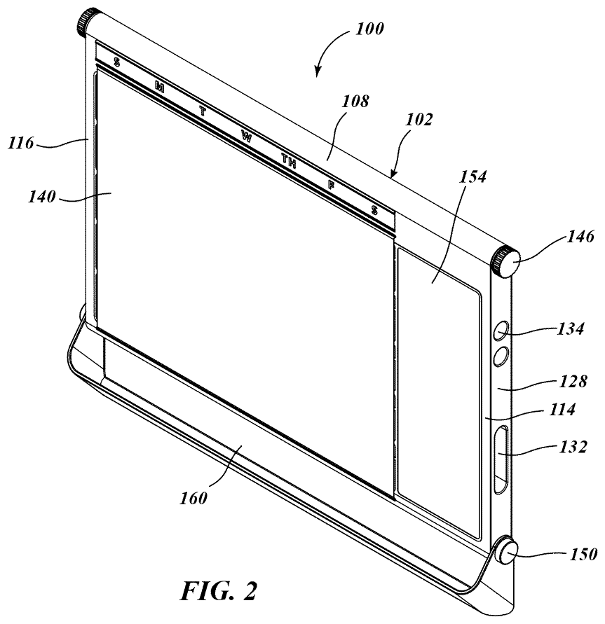

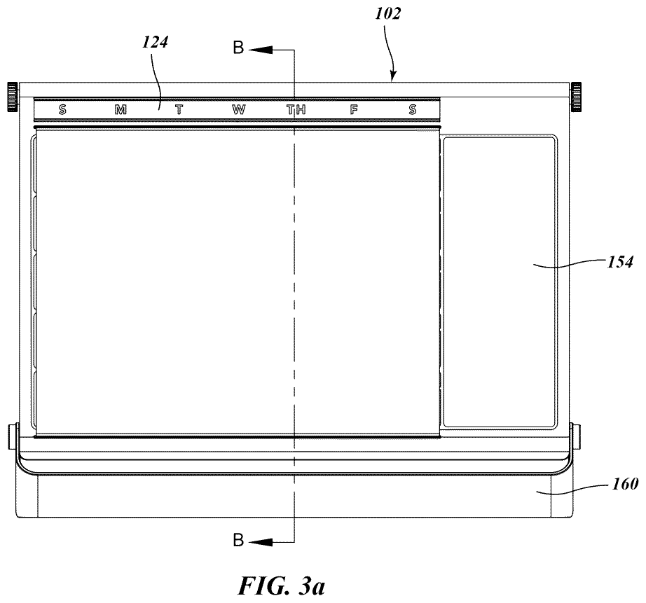

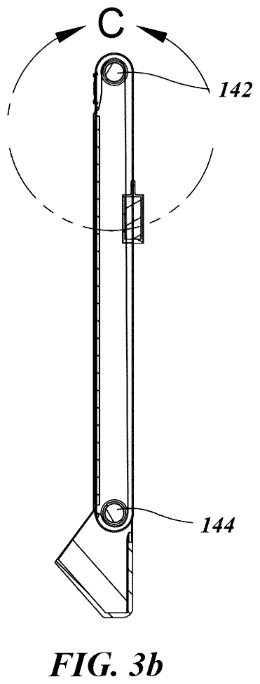

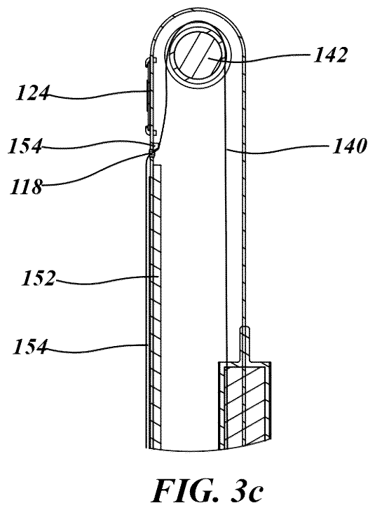

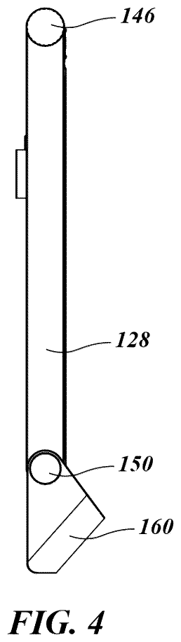

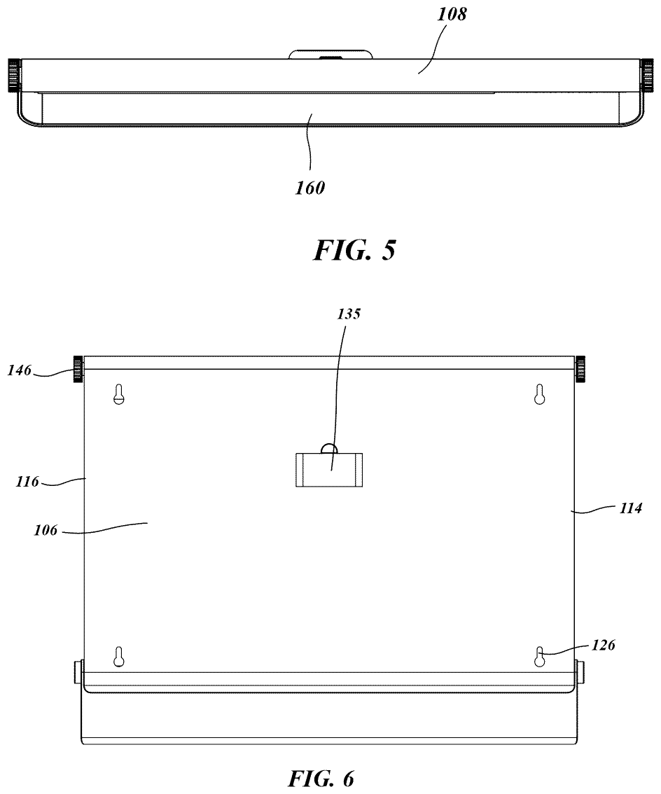

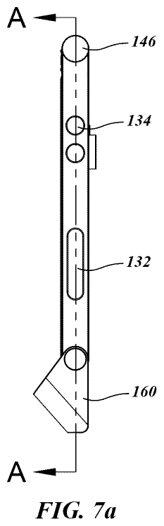

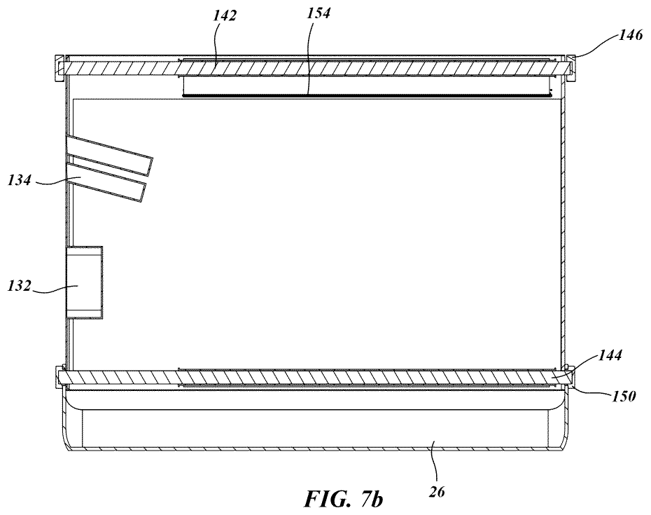

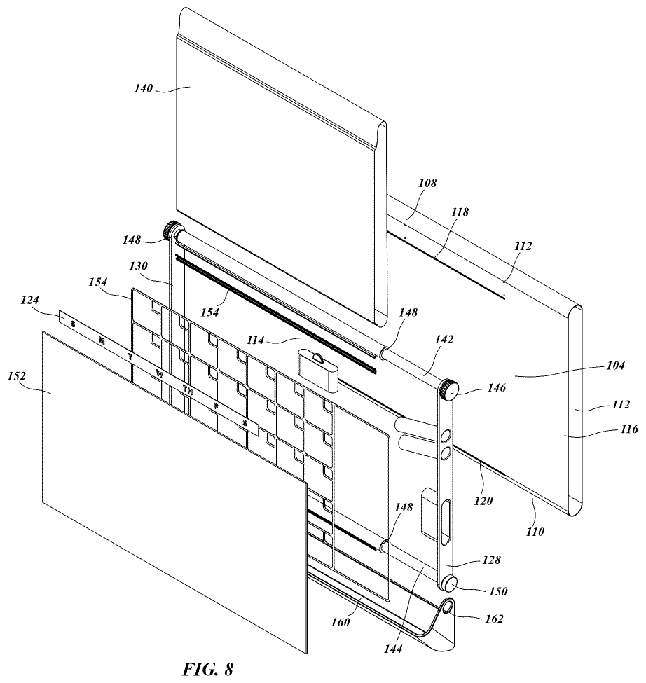

Referring to FIGS. 2-8, an erasable display system is shown generally at 100. The system 100 can comprise a substantially rigid frame 102, which can include a front portion 104 and an opposing back portion 106. The front portion 104 and the back portion 106 can be structurally coupled together via an integral top portion 108 and a complementary bottom portion 110, thereby forming a hollow center region 112 within the frame 102. The top portion 108 and the bottom portion 110 can be such as, for example, radiused, chamfered, beveled, squared, or the like. The front portion 104 and the back portion 106 can further comprises a first lateral side 114 and a second lateral side 116 positioned opposite to the first lateral side 114. The first lateral side 114 and the second lateral side 116 can extend towards each other forming the front portion 104 and the back portion 106, thereby completing the peripheral structure of the frame 102. This configuration creates a substantially open volumetric space defined by the hollow center 112. The back portion 106 can have a compartment 135 to store the days of the week, months or year inserts, or any card for the user to customize for the erasable display system 100.

In certain embodiments, the frame 102 may be fabricated from one or more materials selected from such as, for example, aluminum alloys, steel alloys, titanium alloys, polymeric composites, carbon fiber reinforced polymers, plastics, and combinations thereof. The selection of materials can be optimized to provide the requisite structural integrity while minimizing the overall weight of the system 100.

In embodiments, the front portion 104 may include a top slot 118 and a bottom slot 120 partially extending from the first lateral side 114 and the second lateral side 116 wherein the top slot and the bottom slot can be substantially near the top portion 108 and the bottom portion 110. The front portion 104 can have two horizontal openings a top slot 118 positioned near the top portion 108, and a bottom slot 120 situated near the bottom portion 110. Both slots can extend from substantially near the first lateral side 114 to substantially near second lateral side 116. These slots are designed with specific dimensions to accommodate the insertion of a film 140. The precise positioning of these slots relative to the top and bottom portions ensures optimal functionality as the film is selectively pushed or pulled through the slots.

The front portion 104 can have at least one first mounting hole 122, to accommodate the secure attachment of a label plate 124. The at least one first mounting hole can be positioned to ensure optimal visibility and accessibility for the user while maintaining the structural integrity of the front portion, or in other embodiments the at least one first mounting hole can be omitted. The label plate 124 can serve as a customizable information display that can feature various temporal designations such as days of the week, months of the year, numerical dates, or any other user-defined text or symbols relevant to the user's application.

The back portion 106 can have at least one mounting hole 126, that can accommodate various attachment methods, enabling secure connection to vertical surfaces such as, for example, walls, partitions, panels, or the like. The at least one mounting hole 126 supports multiple installation approaches, including direct wall mounting using appropriate fasteners such as, for example screws or bolts, attachment to magnetic surfaces via compatible magnetic mounting accessories, integration with standardized wall mounting systems commonly found in residential, commercial, or industrial environments.

The at least one mounting hole 126 can be reinforced to withstand sustained weight and provide long-term stability once installed. The diameter and threading specifications of the at least one mounting hole conform to industry standards, ensuring compatibility with widely available fastening hardware. The at least one mounting hole 126 can eliminate the need for specialized tools or custom components during installation, significantly enhancing user convenience and installation flexibility. Additionally, the surrounding material can be reinforced to prevent wear or enlargement of the mounting holes over time, maintaining the structural integrity of the attachment points throughout the operational life of the device.

The system 100 can further comprise a first side panel 128 and a second side panel 130, which can enclose the hollow center region 112 of the frame. The first side panel 128 can align with and connect to the frame's first lateral side 114, while the second side panel 130 is similarly configured to attach to the frame's second lateral side 116. This dual-panel design creates a fully enclosed interior space that protects internal components while contributing to the overall structural integrity of the system. The first side panel 128 and the second side panel 130 can have at least one of a rod receiving apertures aligned to form at least two rotational axes.

The first side panel 128 and the second side panel 130 can be secured to the frame by such as, for example, high-strength industrial adhesives can be applied along the connection points to create a permanent, seamless bond between the components. Alternatively, various fastener systems including self-tapping screws, machine screws with corresponding nuts, or specialized quick-release fasteners can be utilized to allow for potential disassembly and maintenance access. For applications requiring simplified assembly processes, the first side panel 128 and the second side panel 130 can be designed with precise tolerances to enable a secure press fit connection, where the first side panel and the second side panel are held in place through friction between mating surfaces without additional securing elements.

In certain embodiments, the system 100 can have connection points that can incorporate reinforced areas to prevent material fatigue around fastener locations and provides optimal surface area for adhesive applications, ensuring long-term stability regardless of the chosen attachment method. Additionally, gasket materials can be incorporated at the junction points to enhance environmental protection, improving resistance to dust, moisture, or other potential contaminants.

In embodiments, the first side panel 128 can be equipped with specialized storage features to enhance functionality and user convenience. Specifically, the first side panel 128 can have at least one eraser holder 132, which can securely accommodate erasers of various standard dimensions and shapes. The at least one eraser holder 132 can have contoured retention elements that maintain the eraser in a stable position while still allowing for effortless retrieval when needed. In certain embodiments, the interior surface of the at least one eraser holder 132 can include textured elements to minimize movement and prevent accidental dislodging during vibrations or minor impacts to the system.

The first side panel 128 can further comprise at least one marker holder 134 to safely store and protect at least one writing instrument. The at least one marker holder 134 can accommodate various marker diameters and cap designs commonly used. The at least one marker holder 134 can have a combination of such as, for example, friction-fit channels, flexible retention tabs, recessed cavities or the like that securely grasp the marker body or cap while protecting the writing tip from damage or drying out. Both the at least one eraser holder 132 and at least one marker holder 134 can be positioned on the first side panel 128 to optimize accessibility without interfering with the system's primary functions and in other embodiments the at least one eraser holder 132 and at least one marker holder 134 can be on the second side panel 130. In certain embodiments the at least one eraser holder 132 and at least one marker holder 134 can lined with material that can withstand repeated insertion and removal cycles without degradation, while also being compatible with the cleaning agents that might be present on erasers or marker surfaces.

The first side panel 128 can have a top rod hole 136 and a bottom rod hole 138. The top rod hole 136 and the bottom rod hole 138 can be positioned at the upper and lower sections of the first side panel 128, respectively. Correspondingly, the second side panel 130 can have matching the top rod hole 136 and the bottom rod hole 138 that can be aligned with those on the first side panel 128, creating a perfectly parallel axis system when the panels are properly installed. The top rod hole 136 and the bottom rod hole 138 can allow the top rod 142 and the bottom rod 144 to rotate axially freely within the holes. In certain embodiments, the top rod hole 136 and the bottom rod hole 138 can have a bearing which can support the top rod 142 and the bottom rod 144.

In embodiments, the top rod hole 136 and the bottom rod hole 138 can be the mounting infrastructure for the top rod 142 and bottom rod 144, which span horizontally across the interior space between the side panels. The top rod 142 can fit smoothly through both the first side panel's top rod hole 136 and its counterpart on the second side panel 130, while the bottom rod 144 similarly traverses through the bottom rod hole 138 and its corresponding opening on the opposite panel. The diameter specifications of these holes can allow a precise fit that permits uninhibited axial rotation of the rods while preventing any undesirable lateral movement or wobbling. The top rod hole 136 and the bottom rod hole 138 can enable the top rod 142 and bottom rod 144 to rotate freely along their longitudinal axes, facilitating smooth operational movement without resistance or friction-related wear.

In certain embodiments, the top rod hole 136 and bottom rod hole 138 can be equipped with integrated bearing systems. These bearings can be such as, for example, ball bearings, roller bearings, specialized bushings, or the like depending on the specific load requirements and operational parameters—significantly reduce rotational friction and distribute mechanical stress more effectively. The incorporation of these bearing elements extends the operational lifespan of the entire rod system by minimizing wear on both the rods and the hole surfaces, while simultaneously enhancing the smoothness of rotation. The bearings can be sealed to prevent contamination from dust and debris, ensuring consistent performance under various environmental conditions and reducing maintenance requirements throughout the system's service life.

In embodiments, the top rod 142 can extends beyond the exterior surfaces of both the first side panel 128 and the second side panel 130, terminating at a first knob 146 at each end. The first knob 146 can be the primary user interface elements for manual operation of the rod system. Each first knob 146 can be dimensioned with an outer diameter optimized for comfortable hand gripping, featuring textured or contoured surfaces to enhance tactile control even in environments where users may have reduced dexterity or when operating with gloves. The second rod 144 can have a second knob 150 which can extend beyond the exterior surfaces of both the first side panel 128 and the second side panel 130, terminating at a second knob 146 at each end. The second knob 150 can be the same properties as the first knob or it can be a passive knob that rotates as the first knob rotates wherein the second knob can be a smooth surface.

In certain embodiments, the first knob 146 and second knob 150 can be coupled to the top rod 142 and bottom rod 144, respectively, where the inner diameter of the knobs can be marginally smaller than the rod diameter, creating a mechanical interference that ensures a secure attachment through friction. For applications requiring additional security or where higher torque transmission is anticipated, mechanical fasteners such as set screws, pins, or keyway systems can be incorporated into the knob design, allowing for positive mechanical engagement with the rod while potentially facilitating future maintenance or replacement.

In embodiments, the first knob 146 and second knob 150 can be manufactured from materials selected for durability, grip comfort, aesthetic integration or the like. The first knob 146 and second knob 150 can be manufactured from such as, for example, polymers, aluminum, elastomer-overmolded structures, stainless steel, or like that combine a rigid core with a softer exterior grip surface, metals, or the like. The first knob 146 and second knob 150 can incorporate visual indicators such as directional arrows or position markers to provide users with intuitive operational guidance without requiring written instructions.

In embodiments, at least one alignment guide 148 can be coupled the top rod 142 and the bottom rod 144 wherein the at least one alignment guide can position the film between the alignment guides on the top rod and the bottom rod and keep the film from moving axially on the top rod and bottom rod. The at least one alignment guide 148 can ensure film positioning and management during system operation. The at least one alignment guide 148 can have a contoured profile that makes contact with the film edges without causing damage or deformation to the material.

The at least one alignment guides 148 can precisely position the film material in the designated operational zone between the guides on both the top rod 142 and the bottom rod 144, ensuring consistent alignment with any viewing windows or interactive surfaces of the system. The at least one alignment guide 148 can create a physical boundary that prevents any undesirable axial movement of the film along the length of either rod during rotation or operation. The at least one alignment guides 148 can be manufactured from materials selected for their low friction properties when in contact with the film, typically featuring rounded or beveled edges at all film contact points to eliminate any risk of tearing or creasing. In certain embodiments, the at least one alignment guides 148 can have self-adjusting tensioning elements that automatically compensate for variations in film width or environmental expansion and contraction.

The at least one alignment guide 148 can be coupled to the top rod 142 and the bottom rod 144 by such as, for example, positive locking mechanisms, such as set screws with nylon tips to prevent marring of the rod surfaces, spring-loaded detent systems that engage with precision-machined grooves on the rods, split-collar designs that create controlled clamping force when tightened or the like. This attachment ensures that the alignment guides maintain their precise positioning during extended operational periods, while still allowing for adjustment or repositioning during maintenance or when accommodating different film formats. The spacing between opposing alignment guides 148 can be calibrated to provide sufficient clearance for the film while minimizing excess lateral movement, typically incorporating tolerances of between 0.1 mm to 1.0 mm to ensure precise tracking without binding. In certain embodiments, the contact surfaces of the at least one alignment guide 148 can have microscopic texturing to reduce surface tension and minimize the potential for static electricity buildup that could affect film handling.

In embodiments, the system 100 can have a backing 152 and a calendar template 154 wherein the backing and calendar template can be placed between the film and the frame 102 and permanently or removably coupled to the frame, or the backing can be coupled to the frame on the back side of the front panel in the hollow center region 112. The backing 152 and frame 102 can be any suitable shape or size and can be made from such as, for example, plastics, metals, polymers, or the like. The frame 102 can be any suitable shape or size but in the preferred embodiment it can have the shape of a calendar with date box in the corner of each box. The backing 152 can be a structural support element that can provide rigidity and durability, while the calendar template 154 offers visual organization and reference points for time-based information display.

The backing 152 and the calendar template 154 can be positioned in the interface space between the film layer 140 and the frame 102, creating a visual foundation visible through the transparent or translucent film which can allow users to interact with the film while maintaining visual reference to the underlying template. Alternatively, in certain configurations, the backing 152 can be installed on the posterior side of the front panel, securely housed within the hollow center region 112, providing structural support while maximizing the available surface area for the calendar template.

The backing 152 and the calendar template 154 can be permanently couple to the frame by such as, for example, high-strength adhesives, ultrasonic welding, mechanical fastening device, or the like. For applications where periodic replacement or updating is desirable, removable coupling mechanisms can be used such as, for example, magnetic attachment points, hook-and-loop fastener systems, snap-fit connections, or the like that allow for removal without damaging the components. Both the backing 152 and calendar template 154 can be manufactured by such as, for example, thermoplastics, metals, polymer composites or the like. The material selection process considers factors such as expected frequency of handling, environmental exposure conditions, and aesthetic integration with surrounding elements.

The backing 152 and calendar template 154 can be various shapes and sizes to accommodate different user environments and applications. In the preferred embodiment, a standardized calendar layout specifically optimized for time and date management applications wherein date boxes can be positioned in the corner of each calendar cell, following conventional calendar visualization principles for intuitive user interaction. In certain embodiments, the calendar template 154 can rotate vertical or horizontally and can be one or more visible weeks and in other embodiments the calendar template can be any suitable shape and size, removable or permanently attached to the frame 102 and can allow the user to place any type of backing that can be such as, for example, to do lists, meeting notes, personal goals, grocery lists, deadlines, school assignment or the like.

In embodiments, the frame 102 can have at least one frame film guide 154 coupled to it wherein the at least one frame film guide can be coupled to the top slot 118 and the bottom slot 120 keeping the film straight when the film enters the frame through the slots. The at least one film guide 154 can be coupled to both the top slot 118 and the bottom slot 120, creating a controlled pathway for film movement throughout the system. The at least one film guide 154 can maintain proper film alignment and tension as the film traverses through the entry and exit points of the frame structure. The at least one film guide 154 can have contoured surfaces ensure that the film maintains a consistently straight orientation during insertion, movement, and other operations, effectively preventing any unwanted folding, wrinkling, or lateral deviation that could compromise functionality or visual clarity. The material composition and surface finish of these at least one film guide 154 can minimize friction while maximizing durability, allowing for smooth film movement without causing wear or damage to the film edges over extended usage periods.

In embodiments, the system can have a cleaning system coupled to the frame that cleans the film as the user selectively moves the film through the frame. The cleaning system can be two approach system wherein the first position cleans the film with a cleaning agent and the second position dries the film. The user can have access to replace both.

In certain embodiment, the system can have a dual-action cleaning mechanism precisely engineered and securely coupled to the frame assembly. The maintenance feature automatically conditions the film surface as the user selectively advances or retracts the film through the frame. The cleaning system employs a two-stage approach that ensures optimal film clarity and longevity. In the first position, a precision applicator component treats the film with a calibrated amount of specialized cleaning agent, formulated to effectively dissolve and remove dust, oils, and residue without damaging the film substrate or any printed elements. Following this initial treatment, the film can be advanced to the second position where a dedicated drying element removes excess moisture and completes the cleaning cycle, leaving the film surface pristine and ready for use.

Both components of this cleaning system are designed with user serviceability in mind, featuring easily accessible replacement mechanisms that allow for periodic maintenance without requiring specialized tools or technical expertise. The cleaning agent applicator and drying element housings incorporate quick-release mechanisms that facilitate straightforward removal and replacement when consumables are depleted or worn, ensuring continuous optimal performance throughout the system's operational lifespan.

In embodiments, the device 100 can further comprise a bottom tray 160 which can be removably or permanently attached to the bottom rod 144 or the frame 102 through a bottom tray hole 162. The bottom tray 160 can be shaped to hold accessories. The tray 160 can be attached to the system through such as, for example, directly to the bottom rod 144, alternatively to the frame 102 via a precisely dimensioned bottom tray hole 162, or the like. The attachment mechanism offers installation flexibility, allowing for either permanent fixation using adhesives or mechanical fasteners for stable, long-term deployment, or removable mounting that facilitates cleaning and reconfiguration as needed. The bottom tray 160 can have a contoured design with one or more compartments specifically shaped to accommodate and organize various system accessories such as markers, erasers, or specialized tools. The one or more compartments are strategically sized and positioned to prevent items from shifting during use while maintaining easy access for the user. In certain embodiments the bottom tray 160 can be omitted.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. An erasable display system comprising:
a frame having an exterior and a back, a top, a bottom, a first side and a second side defining a hollow interior with an open front;
a first rod running between the first side and the second side and a second rod running between the first side and the second side parallel to the first rod, wherein at least one of the first rod and the second rod has at least one rotation knob that is accessible from the exterior of the frame; and
a flexible, writeable film material scrolled between and around the first rod and the second rod, wherein the film material is configured to be selectively advanced by operation of the at least one rotation knob.

2. The erasable display system of claim 1, further comprising an eraser mounted on the frame, positioned to contact the film material upon rotation of the at least one rotation knob and configured to remove markings from the film.

3. The erasable display system of claim 1, wherein the at least one knob is a first knob coupled to the first rod about the first side and a second knob coupled to the first rod about the second side.

4. The erasable display system of claim 1, wherein the film has an easy-erase coating.

5. The erasable display system of claim 1, wherein the frame, rods, and at least one rotation knob are selected from at least one of wood, metal, and plastic.

6. The erasable display system of claim 1, wherein the film is made from a polymer selected from at least one of polyethylene and polypropylene.

7. The erasable display system of claim 1, further comprising a calendar template configured to allow the film to be used as a progressable calendar.

8. The erasable display system of claim 1, further comprising a motor coupled to at least one of the first rod and the second rod configured to automatically rotate the at least one of the first rod and the second rod to advance the film in response to user settings.

9. The erasable display system of claim 8 wherein the motor is coupled to at least one of the first rod and the second rob by a gear and/or a belt.

10. The erasable display system of claim 8, wherein the motor operation is controlled by a microcontroller for timing or triggering the rotation of the dry erase film based on user inputs.

11. The erasable display system of claim 2, further comprising an adjustable eraser pressure mechanism, wherein the pressure with which the eraser contacts the film is adjustable.

12. The erasable display system of claim 1, further comprising a tension adjustment mechanism configured to adjust the tension of the film to keep it taut and optimal for writing and erasing.

13. The erasable display system of claim 1, wherein the first side panel and/or the second side panel has at least one marker holder and at least one eraser holder.

14. The erasable display system of claim 1 wherein the first rod has a first end that passes through a first rod aperture on the first side of the frame.

15. The erasable display system of claim 7 wherein the calendar template includes an open space in addition to the calendar days configured to allow a user to write additional notes outside of the calendar.

16. A method of assembling an erasable display system, the method comprising:
providing a frame having an exterior and a front, a back, a top, a bottom, a first side and a second side defining a hollow interior;
coupling a first rod to run between the first side and the second side and a second rod to run between the first side and the second side parallel to the first rod;
providing access to at least one of the first rod and the second rod to allow a user to rotate the first rod and/or the second rod;
scrolling a flexible, writeable film material between and around the first rod and the second rod.

17. The method of claim 16 further comprising coupling a template about the film to give a writeable format to the film.

18. The method of claim 16 further comprising coupling an eraser to the frame such that advancing the film passes a portion of the film that has been written on into contact with the eraser to erase any writing on the film that passes by the eraser.

19. The method of claim 16 further comprising coupling a controllable motor to at least one of the first rod and the second rod to automatically advance the film.

20. The method of claim 16 further comprising forming at least one of at least one marker holder and at least one eraser holder in the frame.
